(19) United States
(12) Patent Application Publication
(10) Pub. No.: US 2009/0013497 A1
(43) Pub. Date: Jan. 15, 2009

(54) Pull Strap Assembly for a Sliding Closure

(76) Inventors: Jerrell P. Squyres, Dallas, TX (US); Kelly Lee Miller, Grand Saline, TX (US); Keith Alan Fulp, Alpharetta, GA (US)

Correspondence Address: Carstens & Cahoon, L.L.P., P.O. Box 802334, Dallas, TX, 75380, US

(21) Appl. No.: 11/776,925

(22) Filed: Jul. 12, 2007

(51) Int. Cl. E05F 1/00

(52) U.S. Cl. 16/71

(57) ABSTRACT

Disclosed is a pull strap assembly for attaching to a sliding closure such as a door on the rear of a semitrailer. The pull strap assembly comprises a first band attached to the sliding closure and a second band attached to the first band to prevent the first band from hanging out of the cargo enclosure when the sliding closure is in the closed position.

### TECHNICAL FIELD

This invention relates to a pull strap assembly for use in transport vehicles, such as trucks and trailer vans, which can be used to enclose a cargo area with a sliding closure while insuring the pull strap is kept within the enclosure.

### DESCRIPTION OF RELATED ART

In a typical semi tractor trailer, a horizontal bed or floor is provided for supporting articles being transported. At the rear of such trailers, a sliding closure, such as a sliding door, is often used to gain entry or access to the cargo area of the trailer to unload the cargo. The height from the street or ground level to the floor of the cargo unit can be in excess of four feet. Consequently, when the sliding door or closure is in the open position, it is difficult for an operator standing on the ground or street level to reach up to any handle provided on the bottom portion on the sliding closure in order to close the sliding closure. Thus straps long enough for an operator to reach from the ground level are often attached to the lower portion of the sliding closure to permit an operator to grab the strap while standing at ground level to close the sliding closure.

There are, however, several drawbacks to having a pull strap attached to a sliding closure. For example, because the pull strap needs to be long enough such that a person standing at the ground level can reach the pull strap with his or her arm extended upward, the pull strap can have a significant section of slack when the sliding closure is in the closed position. The strap can then hang outside of the sliding closure. Such hanging strap outside of the sliding closure is undesirable for purposes of safety, aesthetics, and for the longevity of the strap. Consequently, a need exists for an improved pull strap assembly for a sliding closure.

### SUMMARY OF THE INVENTION

The present invention comprises a pull strap assembly comprising a first band attached to a second band. In one embodiment, the second band comprises an elastic band. One end of the first band and one end of the second band are attached to a cargo container wall. 1]he other end of the first band is attached to a sliding closure.

In one aspect, the present invention comprises a pull strap assembly kit comprising the first band attached to the second band and one or more twist plates and one or more back plates for attaching the respective bands to the wall. The above, as well as additional features and advantages of the invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1a is a partial exploded perspective view of the rearward portion of a truck trailer having a pull strap assembly in accordance with one embodiment of the present invention;

FIG. 2a is a perspective view of a pull strap assembly installed in accordance with one embodiment of the present invention;

FIG. 2b is a perspective view of the pull strap assembly installed in accordance with an alternative embodiment of the present invention; and

FIG. 3 is a perspective view of the pull strap assembly depicted in FIG. 2a with the sliding closure closed.

### DETAILED DESCRIPTION

While the invention is described below with respect to one or more preferred embodiments, other embodiments are possible. The concepts disclosed herein apply equally to other systems for providing a pull strap assembly for a sliding closure for cargo areas and storage units including cargo vehicles, cargo containers, and ground level storage devices, such as garages, that have a floor at the ground level, or a loading dock door that will be shut from the outside. It will be readily apparent to those skilled in the art that various modifications, rearrangements, and substitutions can be made without departing from the spirit of the invention. The scope of the invention is defined by the claims appended hereto.

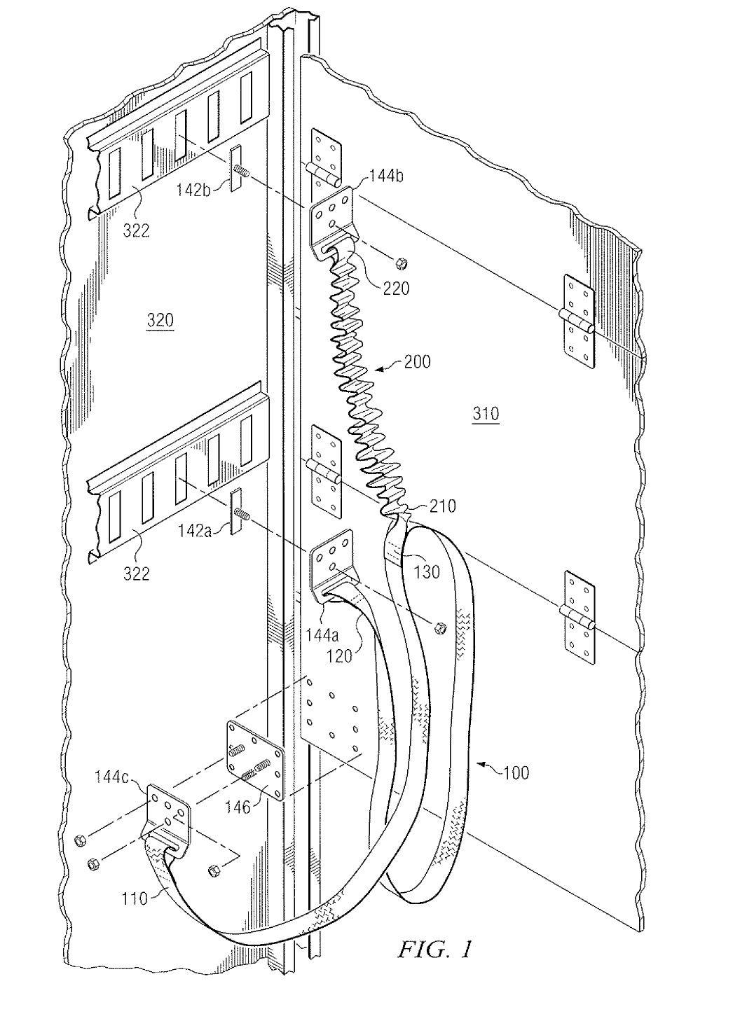

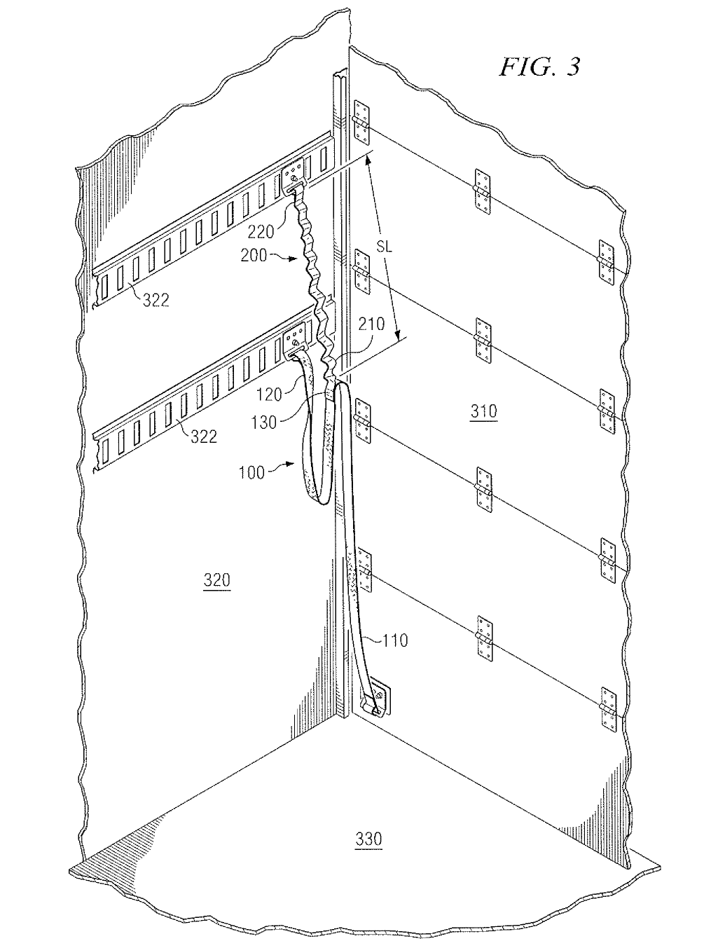

FIG. 1a is a partial exploded perspective view of the rearward portion of a truck trailer having a pull strap assembly in accordance with one embodiment of the present invention. As depicted in FIG. 1, a pull strap assembly for a sliding closure 310 comprises a first band 100 having a first portion 110 secured to the sliding closure 310 and a second portion 120 secured to a wall 320 adjacent the sliding closure 310. A rivet plate 146 can be easily riveted to the bottom portion of the sliding closure 310. One or more threaded male members can protrude from the rivet plate 146 to facilitate attachment of a back plate 144c. The back plate 144a, in one embodiment, comprises apertures for receiving the male threaded protrusions to permit nuts to be fastened over the protrusions to fasten the back plate 144c to the rivet plate 146. In one embodiment, the back plate 144c comprises an elongated aperture so that the first portion 110 of the first band 100 can be secured to the back plate 144c. Similarly, the second portion 120 of the first band 100 can be attached to an elongated aperture of back plate 144a. This back plate 144a can be secured to the wall 320 by fastening the back plate 144a to a twist plate 142a having a threaded male protrusion that can be fastened to the back plate 144a. T he twist plate 142a can be easily secured to the track 322 by placing the twist plate 142a into a track 322 slot and twisting the twist plate 142a such that the major axis is substantially perpendicular to the major axis of the slot of the track 322. A second band 200 having a first end 210 is attached to the first band 100 and the second end 220 of the second band 200 is secured to the wall 320. The second band 200 is attached to a section 130 of the first band 100 so as to prevent the first band 100 from contacting the floor 330 (as shown in FIG. 3 when the door is closed).

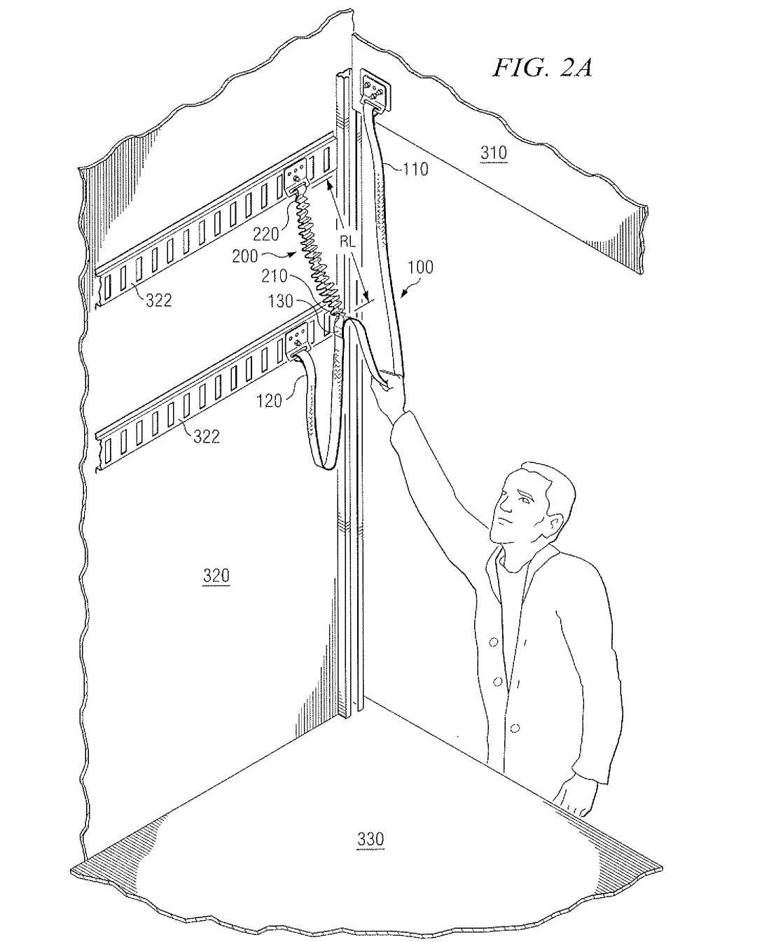

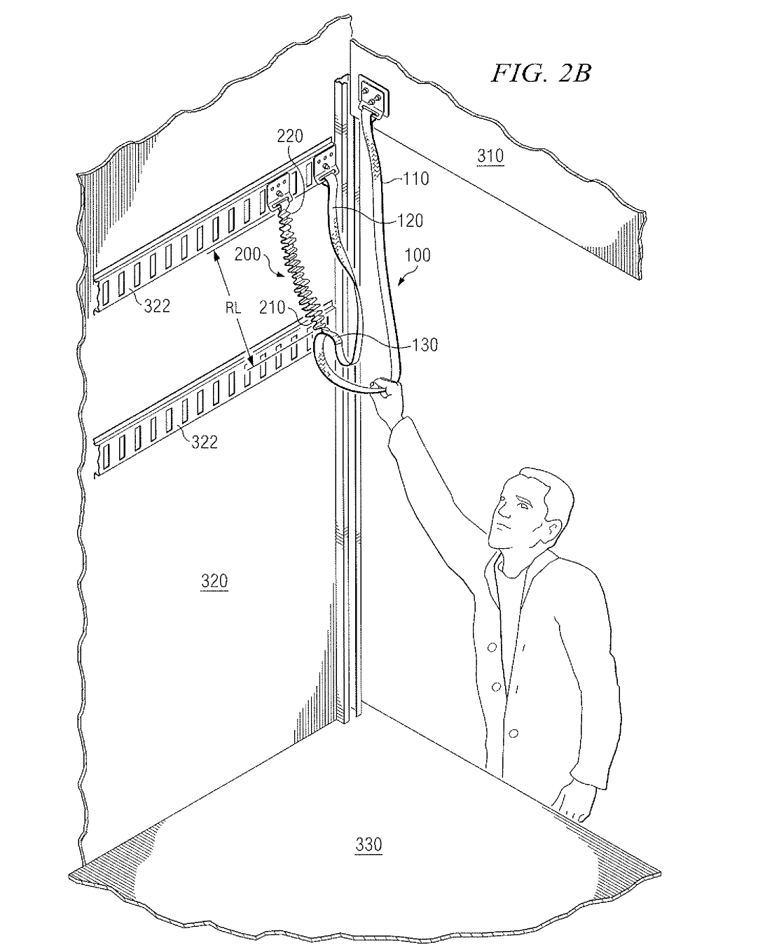

FIG. 2a is a perspective view of a pull strap assembly installed in accordance with one embodiment of the present invention. As shown in FIG. 2a, when installed, an operator is able to reach the first band 100 such that the sliding closure 310 can be closed from the fully open position. The second band 200 as shown comprises an internal elastic band (not shown) having a resting length RL. The resting length RL is long enough to permit the operator to reach the first band 100.

FIG. 3 is a perspective view of the pull strap assembly depicted in FIG. 2a with the sliding closure in a fully closed position. As depicted in FIG. 3, the second band 200 comprises a stretch length SL when the sliding closure 310 is in the fully closed position. As used herein, the fully closed position occurs when the bottom of the sliding closure 310 is in communication with the floor 330. In one embodiment, the second band 200 comprises a rest length RL (as shown in FIG. 2a) of about two feet, or 24 inches, and, in one embodiment, comprises a stretch length SL of about 40 inches.

In one embodiment, the first band 100 comprises a length of about seven feet, one inch. (7′1″). The second band can be attached to the first band by many methods known in the art and, in one embodiment, the second band 200 is sewn to the first band 100. As shown in FIG. 3, when the sliding closure is closed, the second band 200 stretches to a stretch length SL as required to ensure that the first portion 110 is held off the floor 330 so that the band 100 is not permitted to exit the enclosure. Consequently, in one embodiment, the second band 200 in essence holds the first band 100 off of the floor 330 when the sliding closure 310 is in the closed position.

The pull strap assembly of the present invention can be sold as a pull strap kit for an upwards sliding closure. The installation of such kit would be relatively easy since the back plates 144a and 144b can be attached to the wall 320 having a track with only the need for a wrench to tighten the nut. Alternatively, wing nuts could be used and no tools would be necessary to fasten the first and second bands to the wall 320. The rivet plate 146 could be riveted to the sliding closure 310 to fasten the rivet plate 146 to the sliding closure 310. However, although a rivet plate 146 is depicted, other attachment devices could be used. Consequently one embodiment of the present invention comprises a pull strap kit for an upwards sliding enclosure having a first band 100, having a second band 200 attached thereto and at least one twist plate 142 and at least one back plate 144. In one embodiment, the pull strap kit further comprises two twist plates. In an alternative embodiment, the pull strap kit further comprises a rivet plate 146. In one embodiment, the pull strap kit can comprise a first band having a second band, the second band comprising an elastic band attached to the first band, a rivet plate, two twist plates and three back plates. In one embodiment, the back plate 144a 144b 144c all comprise four screw receiving apertures and an elongated strip receiving aperture. In one embodiment, one or more of the back plates 144a 144b 144c comprise an elongated aperture on an angle portion of the back plate. Any suitable angle can be used that facilitates placement of a strap through the elongated aperture when the back plate 144a 144b 144e is fastened to the wall 320 or sliding closure 310. In one embodiment, the elongated aperture is disposed on an angled portion having a 25 degree angle. Of course, such specific angle is provided merely for purposes of illustration and not limitation. Any suitable angle can be used. Further, the elongated aperture is just one geometry that can be used with the flat seat belt-like strip depicted. Other aperture shapes can be used and the shapes can roughly correspond to the shape of the strap being viewed.

While this invention has been particularly shown and described with reference to the preferred embodiment, it will be understood by those skilled in the art that various changes in form and detail may be made therein without departing from the spirit and scope of the invention.

What is claimed is:

1. A pull strap assembly for an upward sliding closure (310) comprising:
a first band (100) having:
a first portion (110) secured to said sliding closure (310); and
a second portion (120) secured to a wall (320) adjacent said sliding closure (310);
a second band (200) having a first end (210) attached to said first band (100) and a second end (220) secured to said first wall (320), wherein said second band (200) is attached to a section (130) of said first band (100) to prevent said first band (100) from contacting a floor (330).

2. The pull strap assembly of claim 1 wherein said second band (200) is an elastic band having a rest length RL and a stretch length SL.

3. The pull strap assembly of claim 1 further comprising at least one twist plate (142) and at least one back plate (144) attached to said wall (320).

4. The pull strap assembly of claim 3 wherein said second portion (120) of said first band (100) is attached to said back plate (144).

5. The pull strap assembly of claim 3 wherein said second end (220) of said second band (200) is attached to said back plate (144).

6. The pull strap assembly of claim 1 wherein sliding closure (310) further comprises a back plate (144) and said first portion (110) of said first band (100) is secured to said back plate (144).

7. The pull strap of assembly of claim 1 wherein said second portion (120) of said first band (100) and said second end (220) of said second band (200) are each attached to a back plate (144) that has been secured to a twist plate (142).

8. A pull strap assembly for an upward sliding closure (310) comprising:
a first band (100) having:
a first portion (110) secured to said sliding closure (310) by a first securing means; and
a second portion (120) secured to a wall (320) adjacent said sliding closure (310) by a second securing means;
a second band (200) having a first end (210) attached to said first band (100) and a second end (220) secured to said first wall (320) by a third securing means, wherein said second band (200) is attached to a portion of said first band (100) to prevent said first band (100) from contacting a floor.

9. The pull strap assembly of claim 8 wherein said first securing means comprises a back plate (144) secured to said sliding closure (310).

10. The pull strap assembly of claim 8 wherein said second securing means comprises back plate (144) that has been secured to a twist plate (142), wherein said twist plate (142) and said back plate (144) are attached to said wall (320).

11. The pull strap assembly of claim 8 wherein said third securing means comprises back plate (144) that has been secured to a twist plate (142), wherein said twist plate (142) and said back plate (144) are attached to said wall (320).

12. The pull strap assembly of claim 8 wherein said first band (100) is an elastic band having a rest length and a stretch length.

13. A pull strap kit for an upward sliding closure (310), said kit comprising:
a first band (100) having a second band (200) attached thereto;
at least one twist plate (142); and
at least one back plate (144).

14. The pull strap kit of claim 13 further comprising two twist plates (142).

15. The pull strap kit of claim 13 further comprising a rivet plate (146).

16. The pull strap kit of claim 13 comprising one rivet plate (146), two twist plates (142), and three back plates (144).

17. The pull strap kit of claim 13 wherein said second band (200) comprises an elastic band.
